(19) United States
(12) Patent Application Publication
(10) Pub. No.: US 2026/0203414 A1
(43) Pub. Date: Jul. 16, 2026

(54) METHOD AND APPARATUS FOR MANAGING SOFTWARE VULNERABILITY INFORMATION

(71) Applicant: ARRIS Enterprises LLC, Horsham, PA (US)

(72) Inventors: Alexander MEDVINSKY, San Diego, CA (US); John I. OKIMOTO, San Diego, CA (US); Tat Keung CHAN, San Diego, CA (US)

(73) Assignee: ARRIS Enterprises LLC, Horsham, PA (US)

(21) Appl. No.: 19/135,025

(22) PCT Filed: Oct. 11, 2023
(86) PCT No.: PCT/US2023/034965

§ 371 Date: Jun. 2, 2025

Related U.S. Application Data
(60) Provisional application No. 63/429,822, filed on Dec. 2, 2022.

(51) Int. Cl. G06F 21/57

(52) U.S. Cl. CPC G06F 21/577; G06F 2221/033

(57) ABSTRACT

A system for that allows software producers to specify a list of software components used in their software products. The system compares that list with information regarding the vulnerability of those components, and identifies which of such components are vulnerable to new or existing threat. The system can be configured to notify software producers of potential vulnerabilities in their software products, as well as those entities authoring the software components used in the software products.

### CROSS-REFERENCE TO RELATED APPLICATIONS

This application is related to the following commonly assigned patent application(s), all of which applications are incorporated by reference herein:

Application Ser. No. 63/348,324, entitled “SOFTWARE DISTRIBUTION SYSTEM AND METHOD,” filed on Jun. 2, 2022, by Alexander Medvinsky et al.

### BACKGROUND

### 1. Field

The present disclosure relates to systems and methods for the authoring and distribution of software, and in particular to a system and method for managing software vulnerability information.

### 2. Description of the Related Art

Many software products are comprised of one or more software modules. Software modules are software components that typically perform a dedicated function, and are often designed so they can be used with a wide variety of software products. One example of a software module is one that performs a cryptographic function, for example, a software module that performs a Rivest-Shamir-Adleman (RSA) decryption operation or a software module that performs an elliptic-curve cryptography (ECC) operation.

One of the disadvantages of using such software modules is that since they are standardized, they present a target for cyber-attacks. Not surprisingly, there has been a proliferation of such cyber attacks that take advantage of known vulnerabilities of those software modules. Exacerbating the problem, software vendors and information technology security teams are not always up to date on remediating the latest security vulnerabilities. What is needed is a system and method for quickly and efficiently providing information regarding the vulnerability of software modules used in software products to software producers.

### SUMMARY

To address the requirements described above, this document discloses a system and method for managing information describing one or more vulnerabilities of a first software product. In one embodiment, the method comprises: accepting, from a first software producer, first information describing the first software product, wherein the first software product comprises a first set of software components, and the first information comprises an identifier of each software component of the first set of software components. The method also comprises accepting, from a database, second information describing one or more vulnerabilities of each of a second set of software components the second set of software components used by a plurality of software products, the second information comprising: an identifier of each software component of the second set of software components, the identifier associated with each vulnerability of the respective software component of the second set of software components, and for each vulnerability of the respective software component of the second set of software components, an identifier of a model of a device upon which each of the second set of software components is installed for execution. The method further comprises storing the first information and the second information in a second database, processing the stored first information and the stored second information to identify vulnerable components of the first software product, and providing each of the identified vulnerable components of the first software product and the respective vulnerability of each of the identified vulnerable components of the first software product.

Another embodiment is evidenced by an apparatus having a processor and a communicatively coupled memory storing processor instructions for performing the foregoing operations. In one embodiment, this method is implemented by a software distribution system that permits consumer users to download software products.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram of the software distribution system and related architecture elements

FIG. 2 is a diagram presenting further details regarding the operation of the software distribution system;

FIG. 3 is a diagram illustrating exemplary operations used to manage geographic restrictions of the software release;

FIG. 4 is a diagram illustrating exemplary operations used to manage restrictions of the software release based on release status;

FIG. 5 is a diagram illustrating further details regarding the integration of licensing features with the software distribution system;

FIG. 6 is a diagram illustrating an exemplary software vulnerability management system;

FIG. 7 is a diagram illustrating exemplary operations performed by the software vulnerability management system;

FIGS. 8A and 8B are diagrams illustrating an exemplary software product and vulnerability information, respectively;

FIG. 9 presents a diagram illustrating an exemplary presentation of such software component vulnerabilities in a tabular format;

FIG. 10 presents a diagram illustrating further exemplary operations performed by the software vulnerability management system; and

FIG. 11 is a diagram illustrating an exemplary computer system that can be used to implement the software vulnerability management system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Overview

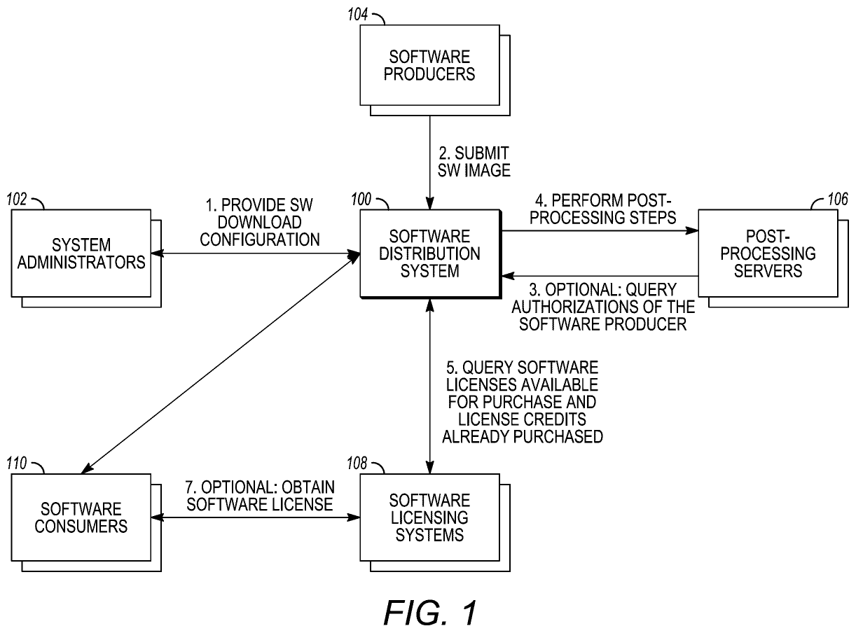

As described above, the use of standardized software modules in software products provides an opportunity for cyber-attacks to compromise the security of software products built using such software modules. It is therefore advantages to provide a means to keep track of which software products use which software components as well the security vulnerabilities of such software components. This allows software producers to be promptly informed of vulnerabilities in their software products. Discussed below is a software vulnerability management system (SVMS) for managing such software vulnerability information. In one embodiment, this system is embodied in a software distribution system, such as the software distribution system described in application Ser. No. 63/348,324, which is hereby incorporated by reference herein and is summarized below with respect to FIGS. 1-5 below. This same software distribution system enables registered and authorized consumers to download software products, and can be configured to check trade compliance parameters of each product, including ECCN (Export Control Classification Number), CCATS (Commodity Classification Automated Tracking System) and encryption commodities, software and technology (ENC) under 15 CFR 740.17 (if the product includes encryption). Based on this info and geographic location of the consumer as optionally, the consumer's company, the system determines if that user is really permitted to download the product. Integration of the SVMS with the software distribution system permits these features to be provided in an integrated platform.

The SVMS allows software producers (vendors) to specify a list of software components (otherwise known as a software bill of materials or SBOM) used in their software products. The SVMS compares that list with information regarding the vulnerability of those components, and identifies which of such components are vulnerable to new or existing threat. The SVMS can be configured to notify software producers of potential vulnerabilities in their software products, as well as those entities authoring the software components used in the software products. Given such notification, the software vendor may assess the potential vulnerability to determine if it is an actual vulnerability or not, and if necessary, develop and make available new versions of the software product which ameliorate such confirmed vulnerabilities. The SVMS supports importation of SBOMs in a standard format, and also provides for the generation of SBOMs from the software product itself, for example, by scanning the software product.

Although not required to practice the invention, the SVMS may be used to notify consumers of software product security vulnerabilities and when they are ameliorated. The SVMS may also be used to automatically (e.g. without manual human assessment) determine security vulnerabilities that applicable to a particular product using the vulnerable software component(s), although this determination may complex because the versions of vulnerable software are not always available via an application program interface (API), and a potential software product vulnerability may not be applicable due to specific deployment details. For example, the vulnerability may be only with a certain portion of function of the software component that is not used or accessed by the software product.

### Software Distribution System

FIG. 1 is a diagram of an software distribution system (SDS) 100 and related architecture elements. The SDS 100 is communicatively coupled to one or more system administrators 102, one or more software producers 104, one or more a post processing servers 106, one or more software licensing systems 108. Software consumers 110 communicate with the SDS to obtain software releases (builds) when completed.

In step 1, the system administrator 102 generates one or more software download configurations (described further below) and provides the software download configuration to the SDS 100. In step 2, the software producer submits one or more software images to the software distribution system 100, and in step 4, the post processing server 106 performs post processing steps as identified in the configured software download configuration provided by the system administrator 102. Optionally, before the post processing steps are performed, the post processing server 106 queries the SDS 100 to assure that the software producer 104 is authorized to have the post processing steps performed on the software image(s) to generate the software release, as shown in step 3.

In step 5, the software distribution system 100 optionally queries a software licensing system 108 to determine whether one or more licenses are associated with the software release (including both required and optional licenses), and to identify which of the identified licenses are available for purchase. In step 6, the software consumer 110 downloads the generated software release from the software distribution system 100 and optionally, obtains the required or optional software licenses from the software licensing system 108, as shown in step 7.

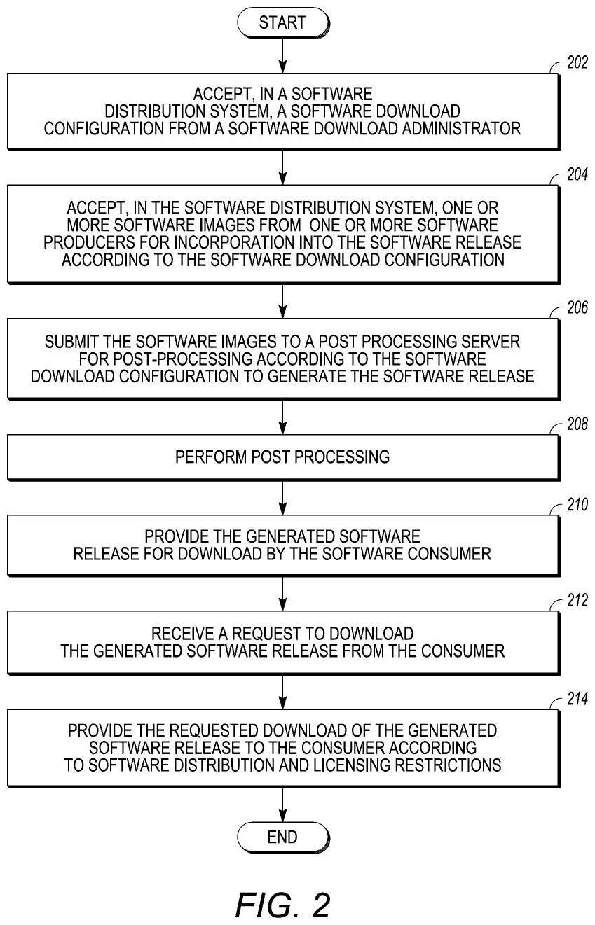

FIG. 2 is a diagram presenting further details regarding the operation of the software distribution system. In block 202, the SDS 100 accepts a software download configuration from the system administrator 102. The system administrator 102 may define the software download configurations offline of the SDS 100 or may interface with the SDS 100 to generate the software download configuration.

### Software Download Configuration

Each software download configuration includes first information defining the post processing to be performed on software images to generate the software release.

The post processing identifies (1) the software image to be included in the software release and (2) one or more post processing operations to be performed on the software image(s). Each post processing operation is associated with a post processing configuration defining how the post processing operation is performed by the post processing server 106. Each software download configuration may also include second information identifying a restriction on the distribution of the software release. Such restrictions may be based on geographic boundaries or license requirements. The restrictions may also be a restriction by software consumer or to a subset of software consumers (e.g. the persons in possession of the devices that will be running the software) to all versions or particular versions of the software release. Distribution may be limited according to other entity definitions as well, for example, a particular software release may be restricted for use by particular device manufacturers or providers of a service.

Returning to FIG. 2, as shown in block 204, the SDS 100 accepts one or more software images from one or more authorized software producer(s) 104 for incorporation into the software release according to the software download configuration provided by the system administrator 102. This can be accomplished via an interactive Graphical User Interface (GUI)-based interface, or with a transactional or Application Program Interface (API)-based interface that can be automated or scripted.

It is possible for different software producers 104 to author software images that are included on a single software release. For example, a first software producer 104 may author and submit the low level bootloader, a second software producer 104 may author and submit a LINUX operating system and root file system, and yet another software producer 104 may submit an image of the application software.

The post processing configurations are typically specified in the software download configuration. However, in cases where they are not provided, the software producer 104 may be permitted to specify which post processing configurations are used by the post processing server 106. The software producer 104 may also be granted sufficient privileges to override the post processing configurations specified in the software download configuration. Further, some software producers 104 may not be given access to all post processing configurations, because some post processing configurations may be confidential or proprietary to particular customers or applications, or software producers 104.

Returning to FIG. 2, as shown in block 206, the SDS 100 submits post processing information comprising the software images (or a processed version of the software image such as a hash) to the post processing server 106 for post processing according to the software download configuration. This step can take place automatically after the software producer 104 uploads the software image, or can take place interactively, through a user interface, with the system administrator 102 or the software producer 104 directing that the post processing steps be performed.

The SDS 100 also submits the post processing configuration identifier or name to the post processing server 106. As described above, the post processing configuration identifier or name specifies a plurality of post processing parameters that describe how the requested operation (e.g. signature, encryption, obfuscation, hash) is to be performed (including, for example, the operation itself, the cryptographic algorithms utilized to perform the operation, which cryptographic keys are used to perform the operation, the output format).

In one embodiment, a check is made to assure that the software producer is authorized to invoke the specified post processing configuration, before the post processing operations are performed to generate the software release. This can be accomplished in a number of different ways. In one embodiment, the SDS 100 enforces the limitation by comparing software producer identifiers (which may include simply alphanumeric IDs or digital certificates) with a list of approved software producers for each post processing configuration invoked. In this embodiment, the SDS 100 receives and manages the authorizations, and only submits the post processing operations for performance by the post processing server(s) 106 if the proper authorization exists for the post processing operations.

In another embodiment, the post processing server 106 verifies that the software producer 104 is authorized to perform the specified post processing operations before permitting the operations to be performed. This can be accomplished by receiving identifying information such as the identifier or digital certificate of the software producer 104 (whether with the post processing request or in response to a query from the post processing server 106), and comparing that identifying information with a list mapping software producers to approved post processing operations. This list may also be provided with the processing request or in advance of such request.

Returning to FIG. 2, presuming that the software producer 104 is authorized to invoke the specified post processing configurations in the request, in block 208, the post processing server 106 performs the indicated operations and returns the resulting software download to the SDS 100.

The SDS 100 provides the generated software release for download by consumers, as shown in block 210. The SDS 100 later receives a request to download the generated software release from a consumer, as shown in block 212, and provides the generated software release according to software distribution restrictions and licensing requirements, as shown in blocks 212 and 214.

In some embodiments, no software license is required for a consumer to download and use the completed software release, and the software release is provided without restrictions. In other embodiments, the customer must meet qualifications before being permitted to download the software release and/or a software license must be obtained by the consumer before using the software release.

### Restrictions on the Distribution of the Software Release

As described above, the software release may be provided according to one or more restrictions. Such restrictions include restrictions based on release status, geographic status (for example, customers located within certain countries may not be permitted to receive a particular download), restrictions based on the identity of the consumer (for example, a particular software release may be destined for all customers except customers in a particular group, or may be restricted to a particular set of consumers (e.g. those in possession of a particular model of device that will execute the software, those consumers that have paid for a particular service)). Such restrictions may affect which post processing operations are specified to be performed by the post processing server 106. For example, some countries may require that a particular encryption algorithm be utilized in the software release, while other countries require other encryption algorithms. Or the application itself may have different functionality based on intended distribution (e.g. one application may utilize digital rights management (DRM) algorithms which are to be used on one brand and model device, while another application for a different device or model may use different DRM algorithms). Restrictions also may include trade compliance parameters of each product, including ECCN, CCATS and ENC (if the product includes encryption).

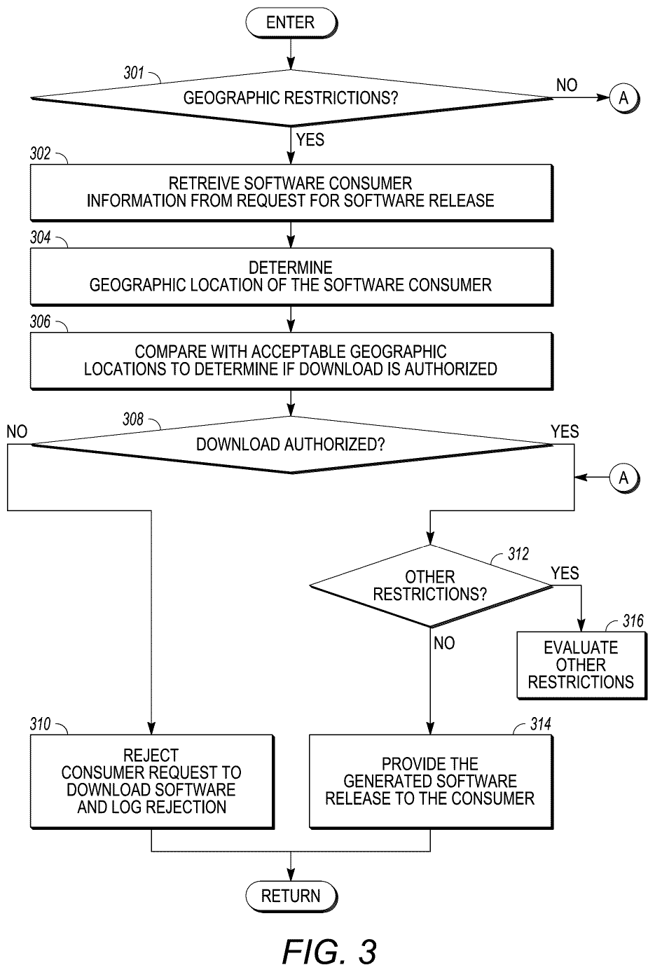

FIG. 3 is a diagram illustrating exemplary operations used to manage geographic restrictions of the software release. In block 301 checks the software download configuration to determine if geographic restrictions are indicated. If no such restrictions are indicated, processing is routed to block 312, which checks if other restrictions are present. If there are no further restrictions, the generated software is provided to the consumer, as shown in block 314. If geographic restrictions are indicated, processing is routed to block 302. In block 302, the SDS 100 receives customer information based on the request for the software release. The customer information can be explicitly provided (for example, an identifier of the customer) or can be determined from the request itself (e.g. the internet protocol (IP) or Media Access Control (MAC) address from which the request originated). The identifier of the customer may include an identifier globally unique to the customer or a class of customer. For example, the identifier may include a model number of the device upon which the software release will be executed, thus identifying the customer as one in possession of a device having that model number.

In block 304, the geographic location of the software consumer is determined from the customer information. This can be accomplished by referring to a mapping between the provided customer information and the indicated location of the customer. For example, if the IP address from which the request originated is used for location information, a mapping between the IP address and the approximate location of the customer is used to determine the customer location.

In block 306, the determined geographic location is compared with acceptable geographic location(s) to determine if the software download is authorized. Block 308 routes processing to block 310 if the software download is not authorized because of geographic restrictions. In this case, the consumer request to download the software release is rejected and the rejection is logged. Block 308 routes processing to block 312 if the software is authorized in light of geographic restrictions. Block 312 checks to determine if other restrictions apply to the software release. The software consumer 110 or software producer's 104 identifying information such as the company name and address may be checked against various embargoes and restrictions. A government may institute prohibitions to deliver software products of any kind or with a specific export control code to a particular country or organization. If no other restrictions apply, the consumer request to download the software release is granted, and processing is routed to block 314 and the generated software release is provided for download. If other restrictions apply, processing is routed to block 316.

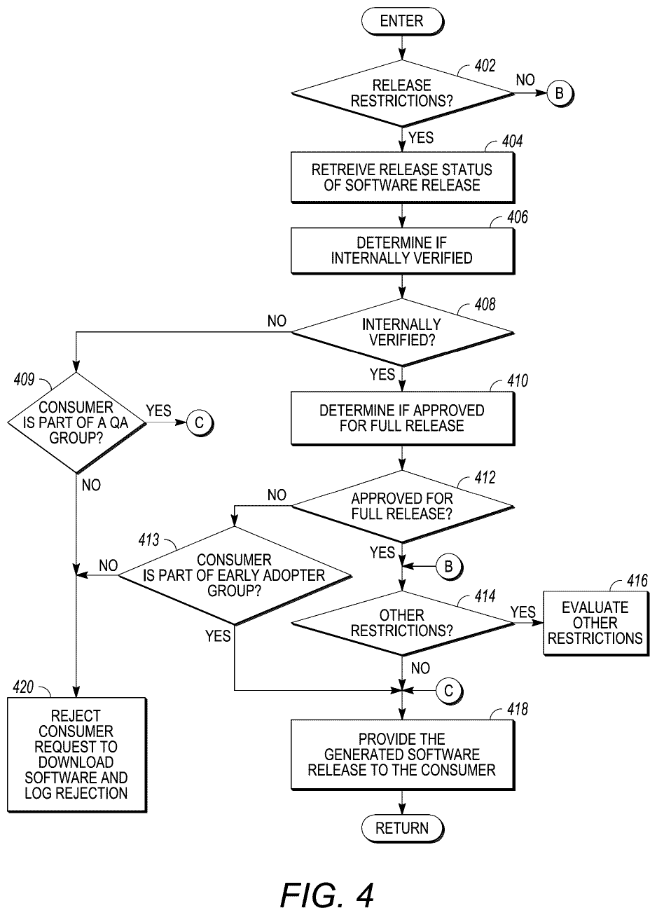

FIG. 4 is a diagram illustrating exemplary operations used to manage restrictions of the software release based on release status. Block 402 determines whether there are any release restrictions for the software release. If not, processing is routed to block 414, which determines whether there are other restrictions regarding the software release. If there are such restrictions, block 414 routes processing to evaluate the other such restrictions, as shown in block 416. If block 402 determines that there are release restrictions, processing is routed to block 404, which retrieves the release status of the software release. The release status is typically set by the system administrator 102 responsible for the software release, and may include a plurality of release statuses, each appropriate for the phase of development of the software. In the illustrated embodiment, three release statuses are envisioned: a first release status indicating that the software release is not yet internally verified, the second release status has been internally verified, but not approved for full release, and a third release status indicating that the software release has been internally verified and is also approved for full release status. The first release status, for example, may restrict it for download only to quality assurance (QA) engineers that belong to the same company as the software producer 104 and perform internal validation of the software release. The second release status, for example, may permit downloading of the software release to one or more individuals and entities that must review the software release and approve for a full release. Turning again to FIG. 4, block 406 determines if the software release has been internally verified. If the software release has been internally verified, block 408 routes processing to block 410, which determines if the software release has been approved for full release. If the software has not been internally verified, block 409 determines if the consumer is part of a QA group which is permitted to download unverified software releases. If yes, then software is released to the consumer in block 418 and otherwise the software download request is rejected in block 420. Likewise, if the software release is approved for full release, block 412 routes processing to block 414, otherwise, in block 413 checks if consumer is part of an early adopter group which is permitted to receive what may for example be called an alpha or a beta release. Block 414 routes processing to block 418, which provides the generated software release to the customer unless other restrictions must be considered.

### Licensing Requirements

As described above, in one embodiment, the SDS 100 queries a software licensing system to determine which licenses (if any) are required for the download and which licenses for optional features may be required if the customer has already purchased or elects to pay for such licenses. The SDS 100 then allows the customer to download the software release, and the software consumer may then obtain licenses (optional or otherwise) from the software licensing system.

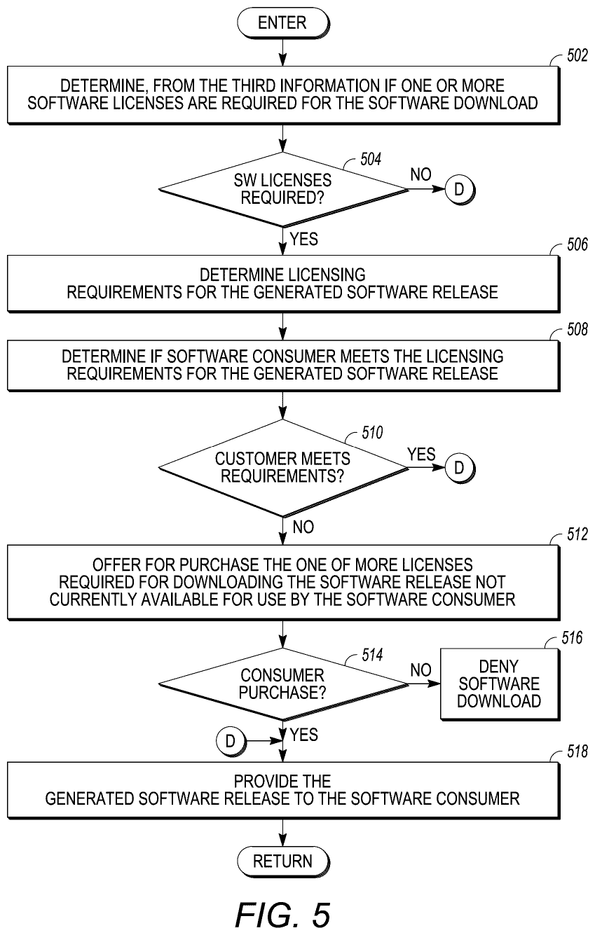

FIG. 5 is a diagram illustrating further details regarding the integration of licensing features with the SDS 100. In block 502, the SDS 100 determines whether one or more software licenses are required for some or all of the functionality of the software release. This is determined from information in the software download configuration. Block 504 routes processing to block 518 if a software license is not required, and to block 506 if a software license is required. If a software license is required, block 506 determines the licensing requirements, by reading and interpreting the information in the software download configuration. Block 508 determines if the software consumer meets the software licensing requirements. This may be accomplished by using the customer-supplied identifier and a mapping between such identifiers and the licensing requirements for the requested software release. For example, as shown in FIG. 1, the SDS 100 may perform the optional step of querying a software licensing system 108 associated with the software release to determine which licenses are available for purchase for the software release, and whether the customer has already purchased the licenses. Such purchases may be in the form of a separate purchase for each license, or credits that are purchased and provided to the consumer that can be exchanged for desired software licenses (e.g. a license to one particular feature of the software release may require three credits, while the a license to another particular feature may require only a single credit).

Block 508 routes processing to block 518 if the customer meets the licensing requirements, and the generated software release is provided to the software consumer. If the consumer does not meet the licensing requirements for the requested software release, block 510 routes processing to block 512, in which an offer to purchase the one or more required licenses for downloading the software release that are not currently available for use by the software consumer (e.g. these software licenses have not been granted to the software consumer). This purchase can be handled by the SDS 100 as a proxy for the software licensing system 108, or the software consumer 110 can be referred to the software licensing system 108 to make the necessary purchases.

Block 514 determines if the customer has purchased the required software licenses. If the required licenses have not been purchased, processing is routed to block 516, and the software download is denied. If the consumer has purchased the required software licenses, processing is routed to block 518, and the generated software release is provided for download.

Software licenses can also be handled by the SDS 100 having post processing operations that modify the software build or release to include a license requirement to unlock some or all of the features of the software release. In this embodiment, the SDS 100 queries the software licensing system(s) 108 to determine which software images require licensing (or whether the entire software release will require a license), and performs the require operations to render the software release usable only with a license. The SDS 100 then builds the software release with these features controlled by licensing requirements and provides the software release to the customer when requested. The software consumer then contacts the relevant software licensing system 108 to obtain the needed licenses.

### Software Vulnerability Management System

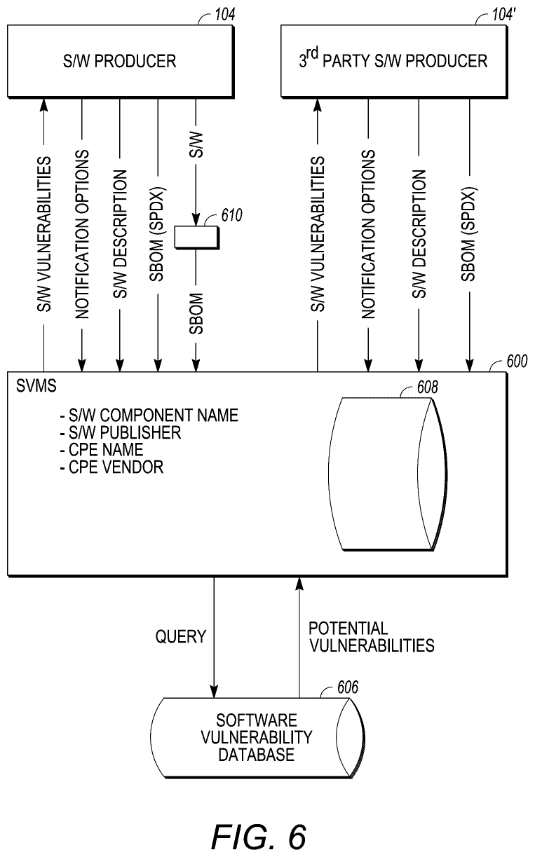

FIG. 6 is a diagram of an exemplary SVMS 600. In one embodiment, the SVMS 600 is implemented as a part of the software distribution system 100 or post processing servers 106.

The SVMS 600 accepts information describing the software product from the software producer 104. This information may include a software description (e.g. name of the software product and its intended purpose) and an SBOM. The SBOM may include an identifier of each software component of the software product (e.g. the name of the software component), the publisher of the software product, the name of the consumer premises equipment (CPE) that the software product will be installed and executed on, and the vendor of the CPE. The SVMS 600 may also accept notification options from the software producer 104 or other administrator, describing whether the software producer 104 wishes to be informed of the vulnerabilities of the software components of the software product, and how and under what circumstances such notifications will be provided.

The SVMS 600 has access to a global software component vulnerability database 606 that stores information describing one or more vulnerabilities of a plurality of software components, including open source software components and those available from third parties. The software component vulnerability database 606 typically includes vulnerability information for software components of the software producer's software product as well as other software components that may form a part of the software product of other of the software producer's software products or software products of other software producers 104′. This information stored in the software component vulnerability database 606 comprises at least an identifier of each plurality of software components stored therein. Database 608 stores relevant software vulnerability information from the software component vulnerability database 606 as well as the information describing the software product and its constituent components.

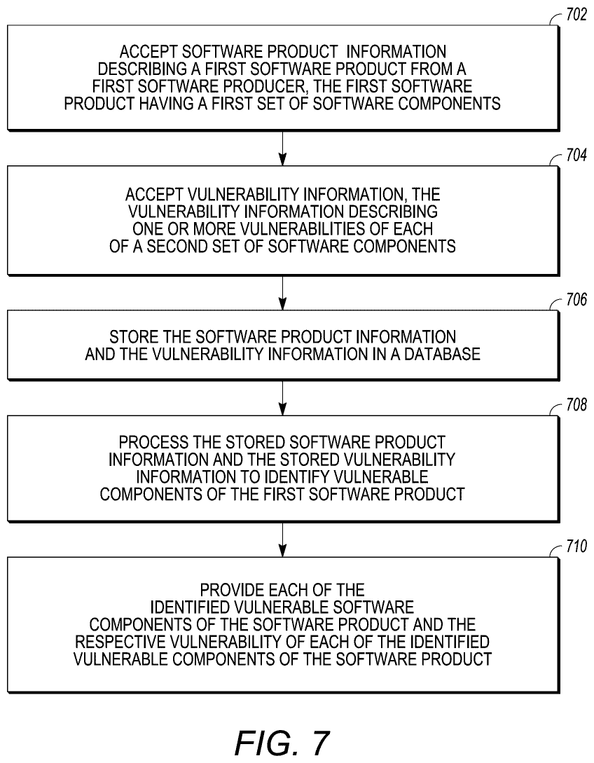

FIG. 7 is a diagram illustrating exemplary operations performed by the SVMS 600. In block 702, the SVMS 600 accepts software product information describing a software product from a software producer 104. As described further below, the software product comprises a first set of software components, and the software product information comprises a software component identifiers (e.g. software component name) for each software component of the software product. The software product information may, at the option of an administrator of the software producer 104, also include a version number of the software component and an identifier of the company or organization that published the software component, for example, the publisher of an open source software component. Further, the software product information may also include an identifier of a device model (consumer premises equipment) upon which the software product is to be installed for execution.

The software product information may be represented by an SBOM. The SBOM may be described in a Software Package Data Exchange (SPDX) format. SPDX is an open standard for communication SBOM information including components, licenses, copyrights, and security references. The SPDX specification is an international open standard (ISO/IEC 5692:2021) and is hereby incorporated by reference herein.

In one embodiment, the operation described in block 702 is performed by a team either employed by or contracted by the software producer 104 that performs audits via a third party forensics lab. This team may generate reports that includes an SBOM as an spreadsheet that can be processed by the SVMS 600. The spreadsheet can be converted into a CSV format before or after provision to the SVMS 600. Multiple SBOMs may exist for the same software product, for example, if ingesting an SBOM for each open source package used in the software product.

In another embodiment, the software product information is generated providing the software product (source code) to a scanner 610. The scanner scans the software product to generate the SBOM, preferably in SPDX format. FOSSA is an example of such a source code scanning tool, as is BLACK DUCK, available from SYNOPSIS. Using such tools the SBOM can be automatically generated and ingested by the SVMS 600.

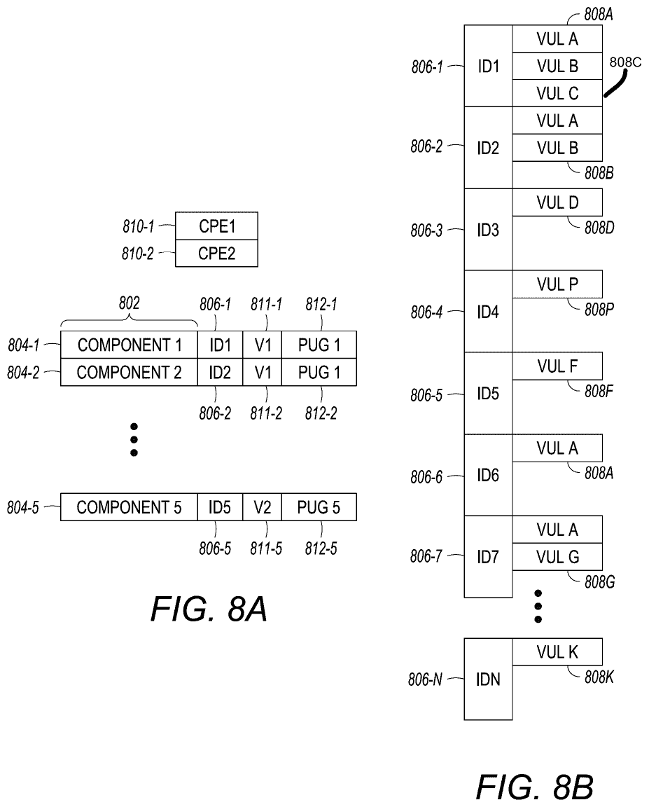

FIG. 8A is a diagram illustrating a software product 802 having five of software components. Although five software components are illustrated, it is to be understood that the software product may have any number of software components. Software components 804-1-804-5 (alternatively individually or collectively referred to hereinafter as software components 804) is associated with a software component identifier 806-1-806-5 and publisher identifier 812-1-812-5, respectively.

In the illustrated example, the software product 802 comprises five software components, including software component 1, software component 2 and software component 5.

Software component 1 has an software component identifier ID1 806-1, associated version number 811-1 (version one or V1) and published by a software component publisher having publisher identifier 812-1 (PUB1). Software component 2 has a software component identifier 806-2 (ID2), associated version number 811-2 (V1) and is published by a software component publisher having publisher identifier 812-2 (also PUB1). Software component 5 has a software component identifier ID5 806-5, associated version number 811-5 (version 2 or V2) and published by the software component publisher having publisher identifier PUB2 812-5 (e.g. a different publisher than the publisher of software components 1 and 2). The software product information may also comprise an identifier of a device model(s) (or alternatively consumer premises equipment or CPE) upon which the software product is to be installed for execution. For example, in the illustrated embodiment of FIG. 8A, the software product is to be installed on CPE 1 810-1 and CPE 2 810-2.

Returning to FIG. 7, block 704 accepts vulnerability information from the software component vulnerability database 606. The vulnerability information comprises an identifier of each software component of a second set of software components (e.g. the set of software components described in the vulnerability database. An example of a software vulnerability database is the National Vulnerability Database (NVD) of the National Institute of Standards and Technology (NIST). The NVD is a U.S. government repository of standards based vulnerability management data represented using the Security Content Automation Protocol (SCAP).

An automated feed of vulnerability may be obtained from the NVD, which enables automation of vulnerability management, security measurement, and compliance. The NVD includes databases of security checklist references, security-related software flaws, misconfigurations, product names, and impact metrics. Other vulnerability databases are available, such as VFEED, available from VFEED, Inc, or VulDB

FIG. 8B is a diagram illustrating an exemplary embodiment of such vulnerability information. The vulnerability information includes an identifier (ID 1-IDN) 806-1-806-N of each software component described in the software component vulnerability database 606, and may comprise one or more vulnerabilities 808A-808K associated with that software component. Of note in the example presented, a software component may have multiple vulnerabilities and a vulnerability may apply to multiple software components. In the example illustrated in FIG. 8B, software component 1 804-1 is associated with software component identifier ID1 806-1, which was authored by publisher PUB1 812-1, and is has vulnerabilities A, B, and C (808A, 808B, and 808C, respectively). Also, component 1 804-1 is also associated with identifiers 810 indicating a device model upon which the software product is to be installed for execution.

Returning again to FIG. 7, block 706 stores the software product information and the vulnerability information in database 608.

Block 708 processes the stored software product information and the stored vulnerability information to identify vulnerable components of the first software product. Such processing may include, for example, storing the software product information and the vulnerability information in a relational database, thus allowing queries to be performed on such databases.

After such storage, a query to identify the vulnerable components of the software product can be performed. In response to this query, the vulnerable software components of the software product can be determined as an intersection of the first set of software components (those software components in the software product) and the second set of software components (software components with known vulnerabilities), then associating the those vulnerable software components with the first software product.

The query may be a manual query (e.g. entered by an operator) or an automatic query (performed according to a schedule set by an operator or administrator of the SVMS 600). The query may, for example, comprise any of (1) an identifier of the software product (2) an identifier of at least one software component of the software product (e.g. at least one software component of the first set of software components), (3) an identifier of the publisher of a software component of the software product, and (4) an identifier of the model of the device upon which one or more of the software products described in the database is to be installed for execution, or any combination thereof.

Querying the database with the identifier of the software product will retrieve vulnerabilities of all of the software components of that software product. This query is useful when checking to determine if a particular software product has software components that have been identified as potentially vulnerable. Querying the database with the identifier of a software component of the software product will retrieve the vulnerabilities of that software component. This query is useful, for example, if a software component is being considered for use in the software product. Querying the database with the identifier of the publisher of the respective component of the software product will retrieve the vulnerabilities of all components associated with that publisher. This query may be useful, for example, when one of a software publisher's software components have been identified as vulnerable, and the user wishes to find other software components in their software products authored by the same software publisher. Finally, querying the database with the identifier identifying the model of the device upon which one or more software products and their constituent software components are to be installed for execution will retrieve the vulnerability of all software components that are installed on the devices that are the subject of the query. This query may be useful, for example, to assure to determine if any potentially vulnerable software components are installed on CPE, and to identify which CPE are implicated.

For example, returning to FIGS. 8A and 8B, it is noted that software component 1 806-1 (ID1) has three vulnerabilities (vulnerability A, vulnerability B, and vulnerability C), that software component 2 (ID2) has two vulnerabilities (vulnerability A 808A and vulnerability B 808B), and software component 5 has vulnerability F 808F. The processing of the software product information and the vulnerability information would identify that software component 1 804-1 is has vulnerabilities A, B, and C (808A, 808B and 808C, respectively), that software component 2 8042 has vulnerabilities A and B, and the software component 5 has vulnerability F 808F.

The processing of the stored software product information and the stored vulnerability information can be implemented by periodic (or on demand) query made against the vulnerability database using the software product information.

Returning again to FIG. 7, block 710 provides each of the identified vulnerable software components of the software product and the respective vulnerability of each of the identified vulnerable software components for further inspection or action. This information may be provided to an administrator, manager, or publisher of the software product.

In addition to alerting a software producer 104 of vulnerabilities in the software components, the SVMS 600 may also optionally be used to provide information regarding newer versions of software components, if available, thus providing the software producer 104 an opportunity to remedy the vulnerability.

### Presentation of Results

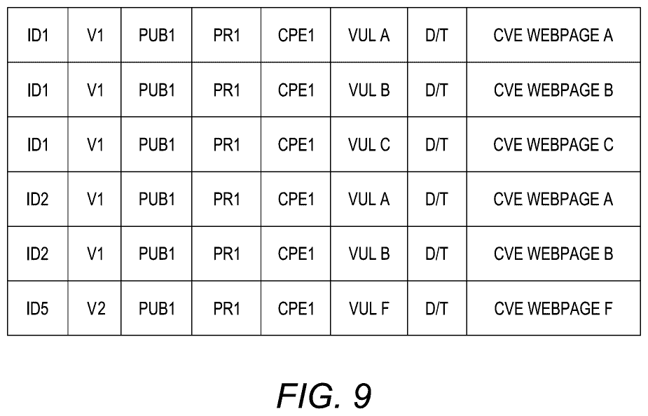

FIG. 9 presents a diagram illustrating an exemplary presentation of such software component vulnerabilities in a tabular format, similar to that of a spreadsheet. In the illustrated embodiment, The first column provides the identifier of the software component, the second column provides the version number of the software component, the third column provides an identifier of the publisher of the software component, and the fourth column indicates the CPE upon which the software component (as a part of the software product, which is identified in the fifth column) is installed for execution. The sixth column indicates the vulnerability associated with the software component, the seventh column indicates a date and time at which the vulnerability became known, and the eighth column provides a hyperlink to software component vulnerability information from an external source such as a common vulnerability exposure (CVE) web page for each entry. Such CVE webpages typically also provide information regarding known remediations, such as using an updated version of the vulnerable software component. Information regarding possible fixes (from the CVE web page, the publisher of the software component, or manually obtained and entered) can also be presented in this interface.

Searching vulnerability databases for particular software component vulnerabilities cannot conclusively determine if the vulnerability is for certain applicable to a specific software product. For example, NVD does not explicitly include version information in the application program interfaces (APIs) used to search the database, and different versions of the same software component may have different vulnerabilities or no vulnerabilities. Further, even if version information is provided as a keywords in a query supported by an API, the sought after vulnerability may not be retrieved from the database. Other vulnerability databases (e.g. vFeed) provides version information for each vulnerability, but such version information is inconsistent. Accordingly, the foregoing processes can be used to identify potential vulnerabilities of software components and the CVE webpage can be used by the operator of the SVMS 600 to investigate whether the potential vulnerability identified by the search is in fact an actual vulnerability of the software product.

Using this link and other information presented, the user may make a determination that a particular potential vulnerability is a threat to that software component (and hence the associated product and CPEs upon which it is installed), and mark it accordingly. Action may then be taken to modify the software product, for example, by substituting a different software component with analogous functionality to the vulnerable one.

Of course, the user may specify the order in which the columns of FIG. 4 are presented, and sort them in ascending or descending order using techniques analogous to those used with spreadsheets. Further, additional information may be presented.

### Manual Entry of Information

Operators may also use the SVMS 600 to manually enter a security vulnerability that is not identified in the software component vulnerability database 606, but is applicable to a particular software component of a software product. In this embodiment, the SVMS 600 accepts third information that includes the identifier at least one software component of the first set of software components (e.g. the software components in the software product), and for each such software component, a further vulnerability of that software component. This further information is then stored in the database 608, and processed along with the first information and the second information to identify vulnerable software components. Further information regarding the software component vulnerability, for example, a measure of the severity of the vulnerability on a scale of 1 to 10, or a score compliant with the common vulnerability scoring system (CVSS).

The operator may also use the SVMS 600 to link an identified vulnerability that was previously entered into the SVMS 600 (whether manually or via software component vulnerability database 606), can be associated with another software product or software component. This entered vulnerability may be marked as confidential, in which case, this information is not shared among other operators or users of the SVMS 600, or not confidential, if the vulnerability can be shared with others. Further, the confidentiality of the vulnerability can be fine tuned so that particular organizations of particular individuals are provided access. A software producer administrator or project manager can manually remove the association of a vulnerability with a software product or a software component, for example, because the association was in error or a software change negates the vulnerability.

### Notifications

An administrator of the SVMS 600 or a product manager of the software producer 104 can configure the SVMS 600 to provide notifications regarding the vulnerabilities of the software product for which they are responsible. This can include (1) notification of one or more newly identified vulnerabilities (2) notification that a previously identified vulnerability has been resolved, or (3) a status of the resolution of a particular vulnerability. Using the SVMS 600, administrators can also set the notifications to be a function of the risk of the associated vulnerability, and can schedule when such notifications occur, and to whom such notifications are provided. For example, a project manager of a software product may specify, for a particular software product that (1) individuals within the software producer 104 are notified and periodically reminded on a configurable schedule that there are high or maximum risk value vulnerabilities (CVSS score of 7.0 or above) associated with a software product (2) the same or other individuals are notified and periodically reminded on a configurable schedule that there are medium risk vulnerabilities (CVSS score of 5.0-7.0) associated with the software product, and (3) the same or other individuals are notified and periodically reminded on a configurable schedule that there are low risk vulnerabilities (CVSS score of less than 5.0) associated with the software product. It is also possible configure the SVMS 600 to notify entities external to the software producer, for example, the author or publisher of the software components that have been identified as vulnerable, again, on a configurable schedule. Notifications may also be provided in response to a specific request (e.g. on demand).

### Third Party Vulnerability Information Handling

In the above embodiment, information regarding the vulnerability of the software components were obtained from the software component vulnerability database 606 or from users of the SVMS 600 within the software producer 104. However, the SVMS 600 may also be configured to accept vulnerability information from third party software producers 104′ and to provide vulnerability information to such producers 104′.

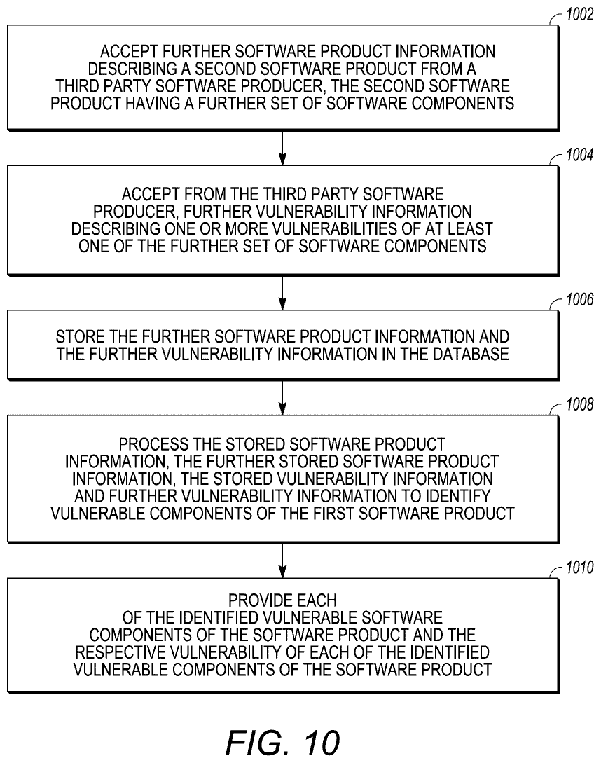

FIG. 10 presents a diagram illustrating further exemplary operations performed by the SVMS 600. In block 1002, information regarding a third party software product (termed as further software product information in FIG. 10) from a third party software producer 104′ is accepted by the SVMS 600 by the third party software producer 104′. The third party software product includes a further set of software components (which may or may not include software components in the first set of software components described above), and the information includes an identifier for each software component of the further set of software components. In block 1004, the SVMS 600 accepts from the third party software producer 104′, further vulnerability information describing one or more vulnerabilities of at least one of the software components of the third party software product.

In block 1006, the further software product information and the further vulnerability information is stored in the database 608. In block 1008, the software product information and vulnerability information (from the first software producer and regarding the first software product) and the further software product information, and further vulnerability information are processed to identify vulnerabilities of the first software product. The identified vulnerable software components of the first software product are identified as the union of (1) the intersection of the first set of software components and the second set of software components (e.g. the intersection of the set of software components in the software product and software components in the software vulnerability database that are vulnerable) and (2) the intersection of the first set of software components and the vulnerable further set of software components (e.g. the intersection of the set of software components in the software products and the further vulnerable software components discovered by the third party and entered into the database 608. Accordingly, additional vulnerable software components and associated vulnerabilities over those previously described are identified, specifically those software component vulnerabilities which were identified by the further software producer that were not available in the software component vulnerability database 606. In block 1010, this information is provided to the user of the SVMS 600.

Importantly, the information provided by software producers 104 regarding their software products need only identify the software components, which are typically open source or software components that are widely adopted. Accordingly, third party software producers 104′ can share this limited information without fear of exposing too much information about their software. Also, by participating in the collection of software component vulnerability information, the third party software producer 104′ also receives such information from other software producers, thus allowing it to more readily identify vulnerabilities in its own software.

### Hardware Environment

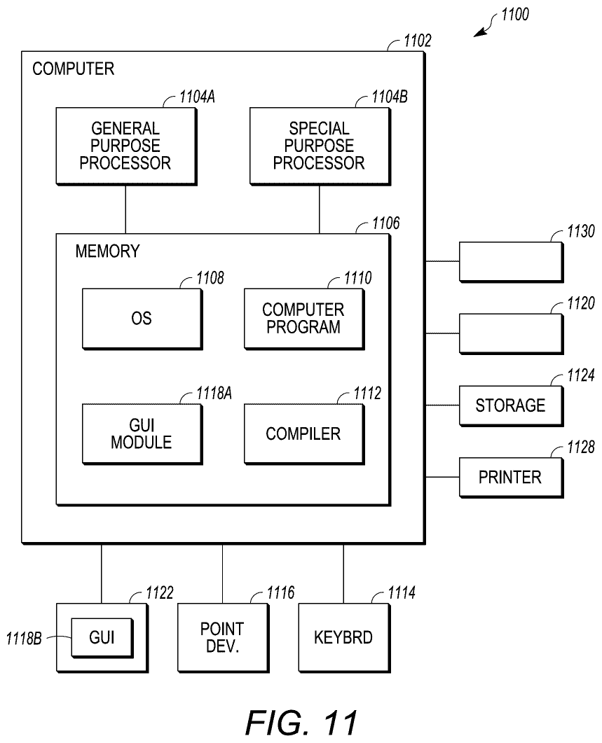

FIG. 11 illustrates an exemplary computer system 1100 that could be used to implement processing elements of the above disclosure, including the SDS 100 and SVMS 600. The computer 1102 comprises a processor 1104 and a memory, such as random access memory (RAM) 1106. The computer 1102 is operatively coupled to a display 1122, which presents images such as windows to the user on a graphical user interface 1118B. The computer 1102 may be coupled to other devices, such as a keyboard 1114, a mouse device 1116, a printer 1128, and the like. Of course, those skilled in the art will recognize that any combination of the above components, or any number of different components, peripherals, and other devices, may be used with the computer 1102.

Generally, the computer 1102 operates under control of an operating system 1108 stored in the memory 1106, and interfaces with the user to accept inputs and commands and to present results through a graphical user interface (GUI) module 1118A. Although the GUI module 1118B is depicted as a separate module, the instructions performing the GUI functions can be resident or distributed in the operating system 1108, the computer program 1110, or implemented with special purpose memory and processors. The computer 1102 also implements a compiler 1112 which allows an application program 1110 written in a programming language such as COBOL, C++, FORTRAN, or other language to be translated into processor 1104 readable code. After completion, the application 1110 accesses and manipulates data stored in the memory 1106 of the computer 1102 using the relationships and logic that was generated using the compiler 1112. The computer 1102 also optionally comprises an external communication device such as a modem, satellite link, Ethernet card, or other device for communicating with other computers.

In one embodiment, instructions implementing the operating system 1108, the computer program 1110, and the compiler 1112 are tangibly embodied in a computer-readable medium, e.g., data storage device 1120, which could include one or more fixed or removable data storage devices, such as a zip drive, floppy disc drive 1124, hard drive, CD-ROM drive, tape drive, and the like. Further, the operating system 1108 and the computer program 1110 are comprised of instructions which, when read and executed by the computer 1102, causes the computer 1102 to perform the operations herein described. Computer program 1110 and/or operating instructions may also be tangibly embodied in memory 1106 and/or data communications devices 1130, thereby making a computer program product or article of manufacture. As such, the terms “article of manufacture,” “program storage device” and “computer program product” as used herein are intended to encompass a computer program accessible from any computer readable device or media.

Those skilled in the art will recognize that many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

The foregoing discloses a method of managing information describing one or more vulnerabilities of a first software product. In one embodiment, the method is manifested by operations comprising: accepting, from a first software producer, first information describing the first software product, wherein the first software product comprises a first set of software components, and the first information comprises an identifier of each software component of the first set of software components. The method further comprises accepting, from a database, second information describing one or more vulnerabilities of each of a second set of software components the second set of software components used by a plurality of software products, wherein the second information comprises an identifier of each software component of the second set of software components, the identifier associated with each vulnerability of the respective software component of the second set of software components; and for each vulnerability of the respective software component of the second set of software components, an identifier of a model of a device upon which each of the second set of software components is installed for execution. The method further comprises storing the first information and the second information in a second database; processing the stored first information and the stored second information to identify vulnerable components of the first software product; and providing each of the identified vulnerable components of the first software product and the respective vulnerability of each of the identified vulnerable components of the first software product.

In another embodiment, the method is evidenced by the above method wherein the first set of software components are open source software components.

In another embodiment, the method is evidenced by any of the above methods wherein accepting, from a first software producer, first information describing the first software product comprise accepting source code of the first software product; scanning the source code of the first software product to identify the first information; and providing the first information.

In another embodiment, the method is evidenced by any of the above methods wherein processing the stored first information and the stored second information to identify vulnerable software components of the first software product comprises determining the vulnerable software components of the first software product as an intersection of the first set of software components and the second set of software components; and associating the vulnerable software components with the first software product.

In another embodiment, the method is evidenced by any of the above methods wherein the first information further comprises an identifier of a version of the respective software component of the first set of software components; an identifier of a publisher of the respective software component of the first set of software components; and wherein processing the stored first information and the second information to identify vulnerable components of the first software product comprises accepting a query to identify the vulnerable components of the first software product, wherein: the query is a manual query or an automatic query; the query comprises at least one of: an identifier of the first software product; an identifier of at least one software component of the first set of software components; an identifier of the publisher of the respective component of the first set of components; and the identifier of the model of the device upon which the first software product is to be installed for execution.

In another embodiment, the method is evidenced by any of the above methods wherein each respective vulnerability is associatively presented with the associated identified vulnerable software component and the identifier of the device model.

In another embodiment, the method is evidenced by any of the above methods wherein the information is managed in a software distribution system; each of the identified vulnerabilities are further associatively presented with a link to an external source presenting software vulnerability information; and the method further comprises: modifying the first software product according to the presented software vulnerability information; and providing the modified first software product to a consumer of the software product using the software distribution system.

In another embodiment, the method is evidenced by any of the above methods wherein the method further comprises accepting third information and storing the third information in the second database. The third information describes an identifier of at least one of the first set of software components, the identifier associated with a further vulnerability of the respective software component; and for the at least one of the first set of software components, an identifier of a model of the device upon which the first set of software components are installed for execution. The method also further comprises storing the third information in the second database. Further, processing the stored first information and the stored second information to identify vulnerable components of the first software product comprises: processing the stored first information, the stored second information and the stored third information to identify vulnerable components of the first software product.

In another embodiment, the method is evidenced by any of the above methods wherein the method further comprises: accepting, from a second software producer, third information describing a further software product; accepting, from the second software producer, fourth information describing one or more vulnerabilities of at least one of the further set of software components; and storing the third information and the fourth information in the second database, wherein the further software product comprises a further set of software components; and the third information comprises an identifier for each software component of the further set of software components; the fourth information comprises: an identifier for each software component of the further set of software components, the identifier associated with each vulnerability of a respective software component of the further set of software components; and for each vulnerability and each respective software component of the further set of software components, an identifier of a model of the device upon which each of the further set of software components is installed for execution; and processing the stored first information and the second information to identify the vulnerabilities of the first software product comprises processing the stored first information, the second information, the third information, and the fourth information to identify the vulnerabilities of the first software product.

In another embodiment, the method is evidenced by any of the above methods wherein processing the stored first information and the stored second information, the stored third information and the stored fourth information to identify vulnerable components of the first software product comprises: determining vulnerable software components of the first software product as a union of an intersection of the first set of software components and the second set of software components, and an intersection of the first set of software components and the vulnerable further set of software components.

In another embodiment, the method is evidenced by any of the above methods wherein the one or more of the vulnerabilities of the second set of software components is associated with a risk value; and the processing of the stored first information and the stored second information to identify vulnerable components of the first software product is configured to be automatically performed according to a schedule; and the method further comprises: determining if any of the identified vulnerable components is associated with a risk value exceeding a configurable maximum risk value; and notifying the first software producer if any of the identified vulnerable components is associated with a risk value exceeding the configurable maximum risk value.

Other embodiments are evidenced by an apparatus having a processor and a communicatively coupled memory storing processor instructions for performing operations described by the foregoing methods and combinations. In one embodiment, this method is implemented by a software distribution system that permits consumer users to download software products.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method of managing information describing one or more vulnerabilities of a first software product, comprising:
accepting, from a first software producer, first information describing the first software product, wherein:
the first software product comprises a first set of software components;
the first information comprises:
an identifier of each software component of the first set of software components;
accepting, from a database, second information describing one or more vulnerabilities of each of a second set of software components the second set of software components used by a plurality of software products, the second information comprising:
an identifier of each software component of the second set of software components, the identifier associated with each vulnerability of the respective software component of the second set of software components;
for each vulnerability of the respective software component of the second set of software components, an identifier of a model of a device upon which each of the second set of software components is installed for execution;
storing the first information and the second information in a second database;
processing the stored first information and the stored second information to identify vulnerable components of the first software product; and
providing each of the identified vulnerable components of the first software product and the respective vulnerability of each of the identified vulnerable components of the first software product.

2. The method of claim 1, wherein the first set of software components are open source software components.

3. The method of claim 1, wherein:
accepting, from a first software producer, first information describing the first software product comprises:
accepting source code of the first software product;
scanning the source code of the first software product to identify the first information; and
providing the first information.

4. The method of claim 1, wherein processing the stored first information and the stored second information to identify vulnerable software components of the first software product comprises:
determining the vulnerable software components of the first software product as an intersection of the first set of software components and the second set of software components; and
associating the vulnerable software components with the first software product.

5. The method of claim 4, wherein:
the first information further comprises:
an identifier of a version of the respective software component of the first set of software components;
an identifier of a publisher of the respective software component of the first set of software components;
processing the stored first information and the second information to identify vulnerable components of the first software product comprises:
accepting a query to identify the vulnerable components of the first software product; wherein:
the query is a manual query or an automatic query;
the query comprises at least one of:
an identifier of the first software product;
an identifier of at least one software component of the first set of software components;
an identifier of the publisher of the respective component of the first set of components; and
the identifier of the model of the device upon which the first software product is to be installed for execution.

6. The method of claim 5, wherein:
each respective vulnerability is associatively presented with the associated identified vulnerable software component and the identifier of the device model.

7. The method of claim 6, wherein:
the information is managed in a software distribution system;
each of the identified vulnerabilities are further associatively presented with a link to an external source presenting software vulnerability information; and
the method further comprises:
modifying the first software product according to the presented software vulnerability information; and
providing the modified first software product to a consumer of the software product using the software distribution system.

8. The method of claim 1, wherein:
the method further comprises:
accepting third information describing:
an identifier of at least one of the first set of software components, the identifier associated with a further vulnerability of the respective software component; and
for the at least one of the first set of software components, an identifier of a model of the device upon which the first set of software components are installed for execution;
storing the third information in the second database; and and wherein:
processing the stored first information and the stored second information to identify vulnerable components of the first software product comprises:
processing the stored first information, the stored second information and the stored third information to identify vulnerable components of the first software product.

9. The method of claim 1, wherein:
the method further comprises:
accepting, from a second software producer, third information describing a further software product, wherein:
the further software product comprises a further set of software components; and
the third information comprises:
an identifier for each software component of the further set of software components;
accepting, from the second software producer, fourth information describing one or more vulnerabilities of at least one of the further set of software components, the fourth information comprising:
an identifier for each software component of the further set of software components, the identifier associated with each vulnerability of a respective software component of the further set of software components; and
for each vulnerability and each respective software component of the further set of software components, an identifier of a model of the device upon which each of the further set of software components is installed for execution;
storing the third information and the fourth information in the second database; and wherein:
processing the stored first information and the second information to identify the vulnerabilities of the first software product comprises:
processing the stored first information, the second information, the third information, and the fourth information to identify the vulnerabilities of the first software product.

10. The method of claim 9, wherein:
processing the stored first information and the stored second information, the stored third information and the stored fourth information to identify vulnerable components of the first software product comprises:
determining vulnerable software components of the first software product as a union of:
an intersection of the first set of software components and the second set of software components, and
an intersection of the first set of software components and the vulnerable further set of software components.

11. The method of claim 1, wherein:
the one or more of the vulnerabilities of the second set of software components is associated with a risk value; and
the processing of the stored first information and the stored second information to identify vulnerable components of the first software product is configured to be automatically performed according to a schedule; and
the method further comprises:
determining if any of the identified vulnerable components is associated with a risk value exceeding a configurable maximum risk value; and
notifying the first software producer if any of the identified vulnerable components is associated with a risk value exceeding the configurable maximum risk value.

12. An apparatus for managing information describing one or more vulnerabilities of a first software product, comprising:
a processor;
a memory, communicatively coupled to the processor, the memory storing processor instructions comprising processor instructions for:
accepting, from a first software producer, first information describing the first software product, wherein:
the first software product comprises a first set of software components;
the first information comprises:
an identifier of each software component of the first set of software components;
accepting, from a database, second information describing one or more vulnerabilities of each of a second set of software components the second set of software components used by a plurality of software products, the second information comprising:
an identifier of each software component of the second set of software components, the identifier associated with each vulnerability of the respective software component of the second set of software components;
for each vulnerability of the respective software component of the second set of software components, an identifier of a model of a device upon which each of the second set of software components is installed for execution;
storing the first information and the second information in a second database;
processing the stored first information and the stored second information to identify vulnerable components of the first software product; and
providing each of the identified vulnerable components of the first software product and the respective vulnerability of each of the identified vulnerable components of the first software product.

13. The apparatus of claim 12, wherein the processor instructions for processing the stored first information and the stored second information to identify vulnerable software components of the first software product comprise processor instructions for:
determining the vulnerable software components of the first software product as an intersection of the first set of software components and the second set of software components; and
associating the vulnerable software components with the first software product.

14. The apparatus of claim 13, wherein:
the first information further comprises:
identifier of a version of the respective software component of the first set of software components;
an identifier of a publisher of the respective software component of the first set of software components;
the processor instructions for processing the stored first information and the second information to identify vulnerable components of the first software product comprise processor instructions for:
accepting a query to identify the vulnerable components of the first software product; wherein:
the query is a manual query or an automatic query;
the query comprises at least one of:
an identifier of the first software product;
an identifier of at least one software component of the first set of software components;
an identifier of the publisher of the respective component of the first set of components; and
the identifier of the model of the device upon which the first software product is to be installed for execution.

15. The apparatus of claim 14, wherein:
each respective vulnerability is associatively presented with the associated identified vulnerable software component and the identifier of the device model.

16. The apparatus of claim 15, wherein:
each of the identified vulnerabilities are further associatively presented with a link to an external source presenting software vulnerability information; and
the processor instructions further comprise processor instructions for:
modifying the first software product according to the presented software vulnerability information.

17. The apparatus of claim 12, wherein:
the processor instructions further comprise processor instructions for:
accepting third information describing:
an identifier of at least one of the first set of software components, the identifier associated with a further vulnerability of the respective software component; and
for the at least one of the first set of software components, an identifier of a model of a device upon which the first set of software components are installed for execution;
storing the third information in the second database; and wherein:
the processor instructions for processing the stored first information and the stored second information to identify vulnerable components of the first software product comprise processor instructions for:
processing the stored first information, the stored second information and the stored third information to identify vulnerable components of the first software product.

18. The apparatus of claim 12, wherein:
the apparatus further comprises processor instructions for:
accepting, from a second software producer, third information describing a further software product, wherein:
the further software product comprises a further set of software components; and
the third information comprises:
an identifier for each software component of the further set of software components;
accepting, from the second software producer, fourth information describing one or more vulnerabilities of at least one of the further set of software components, the fourth information comprising:
an identifier for each software component of the further set of software components, the identifier associated with each vulnerability of a respective software component of the further set of software components; and
for each vulnerability and each respective software component of the further set of software components, an identifier of a model of a device upon which each of the further set of software components is installed for execution;
storing the third information and the fourth information in the second database; and wherein:
the processor instructions for processing the stored first information and the second information to identify the vulnerabilities of the first software product comprise processor instructions for:
processing the stored first information, the second information, the third information, and the fourth information to identify the vulnerabilities of the first software product.

19. The apparatus of claim 18, wherein:
the processor instructions for processing the stored first information and the stored second information, the stored third information and the stored fourth information to identify vulnerable components of the first software product comprise processor instructions for:
determining vulnerable software components of the first software product as a union of:
an intersection of the first set of software components and the second set of software components, and
an intersection of the first set of software components and the vulnerable further set of software components.

20. An apparatus for managing information describing one or more vulnerabilities of a first software product, comprising:
means for accepting, from a first software producer, first information describing the first software product, wherein:
the first software product comprises a first set of software components;
the first information comprises:
an identifier of each software component of the first set of software components;
means for accepting, from a database, second information describing one or more vulnerabilities of each of a second set of software components the second set of software components used by a plurality of software products, the second information comprising:
an identifier of each software component of the second set of software components, the identifier associated with each vulnerability of the respective software component of the second set of software components; and
for each vulnerability of the respective software component of the second set of software components, an identifier of a model of a device upon which each of the second set of software components is installed for execution;
means for storing the first information and the second information in a second database;
means for processing the stored first information and the stored second information to identify vulnerable components of the first software product; and
means for providing each of the identified vulnerable components of the first software product and the respective vulnerability of each of the identified vulnerable components of the first software product.
